(19) United States
(12) Patent Application Publication
(10) Pub. No.: US 2008/0215440 A1
(43) Pub. Date: Sep. 4, 2008

(54) REFILLABLE PACKAGE FOR CONSUMABLE PRODUCTS

(75) Inventors: Robert J. Peterson, Crystal Lake, IL (US); James A. Bougoulas, Chicago, IL (US)

Correspondence Address: BELL, BOYD & LLOYD LLP, P.O. Box 1135, CHICAGO, IL, 60690, US

(73) Assignee: Wm. Wrigley Jr. Company, Chicago, IL (US)

(21) Appl. No.: 12/040,779

(22) Filed: Feb. 29, 2008

Related U.S. Application Data
(60) Provisional application No. 60/892,479, filed on Mar. 1, 2007.

(51) Int. Cl. G06Q 30/00; B65D 21/00; B65D 83/04; B65B 1/04; B65B 43/38

(52) U.S. Cl. 705/14; 220/23.87; 206/531; 53/473; 53/492

(57) ABSTRACT

A refillable container is provided for dispensing a plurality of consumable products. The container may comprise a reclosable container and a refill package. The reclosable container may comprise a lid connected to a body defining a container interior. The refill package may comprise a tray and a removable closure. The tray may be configured to fit and lock inside the container interior. There may be at least one gripping portion defined along an interior of the tray. The gripping portion may be so constructed and arranged to enable a user to disengage the tray from the container body.

### BACKGROUND

The present disclosure relates generally to packaging. More specifically, the present disclosure relates to containers for storing and dispensing consumable products. Several aspects of storing and dispensing consumable products may be discussed in the present disclosure including, but not limited to, protecting the products from being damaged during shipping and maintaining the freshness of the products.

Some consumable products do not require that the packaging be robust, sturdy or disposable. On the other hand, in certain instances, packaging can allow a user to access consumable products without having to consume all of the products at one time. In such an instance, the manufacturer may wish to provide a package that is secure, reclosable and reusable.

Additionally, where a product consists of a number of small solid pieces, traditional containers are primarily useful for maintaining the small pieces in a restricted space for portability. However, where the containers are larger, they may prove more useful for maintaining many small pieces in a convenient, often decorative, manner.

Packaging is also an important aspect of the marketing of the product the package contains. As such, containers for products, such as consumable products, come in a variety of sizes, shapes and designs. With variation of these characteristics for marketing purposes, packaging can convey a wide array of information to the consumer whereby the consumer may then associate a product with a specific characteristic of that product by simply viewing the product packaging. Once the consumer has identified a desired brand, the consumer can typically choose a product based solely on the type of packaging.

Very often, in addition to the text of the packaging, the packaging may convey a message about the product, the quality of the product, or the purpose of the product simply by adding aesthetic designs, simple indicators or indicia or even other sensory triggers. For example, certain packages marketed towards children can include an array of vivid colors, easy to read descriptions, or interactive components to convey an amusing and fun message about the product. Also, certain packages marketed towards adults can include lush fabrics and materials to convey the luxury and quality associated with the product.

In this regard, it is desirable to create a container with an aesthetically pleasing and sophisticated look. Conventional metal containers are aesthetically pleasing to consumers and may convey an overall contemporary feeling associated with the product. However, manufacturing containers made of metal may be more costly than manufacturing containers from other materials including, but not limited to, plastic materials.

Furthermore, manufacturing reclosable containers that are small and portable may also be costly due to the little amount of consumable product that each container holds.

An object of the present disclosure is to solve the deficiencies of the prior art.

### SUMMARY

The present disclosure provides a refillable package for dispensing a plurality of consumable products. The package may comprise a reclosable container and a refill pack. The container and the refill pack may be manufactured from different materials. The reclosable container can include an aesthetically pleasing exterior and an interior defined by a reclosable lid and a body. The refill pack may be so constructed and arranged as to be inserted and lock within the container interior. The refill pack may also include a grip portion allowing a consumer to separate and lift the refill pack from the container interior when the refill pack is empty. The present disclosure also relates to a method for marketing products housed within a refillable package.

In an embodiment, the present disclosure provides a package including a container and a removable refill. The container has a lid, a body defining a container interior, and a bead. The refill comprises an insert defining an insert interior housing a plurality of products and a removable closure covering the insert interior. The insert is so constructed and arranged to be received within a portion of the container interior and cooperating with the bead to secure the insert within the container interior.

In an embodiment, the insert is made from a deformable plastic.

In an embodiment, the lid and the body are connected by a hinge.

In an embodiment, the products are shaped as tablets.

In an embodiment, the closure is removably attached to the insert.

In another embodiment, a package includes a deformable body having an interior housing, a plurality of products and an inner surface comprising a pair of grips. The grips extend toward the interior and are so constructed and arranged as to allow the deformable body to be carried thereby. A closure removably covers the interior housing.

In an embodiment, the pair of grips are located on opposing sides of the inner surface.

In an embodiment, the plurality of products is a plurality of solid consumable products.

In an embodiment, the deformable body is made from thermoform plastic.

In an embodiment, the closure is a film.

In an additional embodiment, a package may comprise a reclosable container and a refill. In this embodiment, the reclosable container may comprise a lid and a body having a container interior. The refill may comprise a deformable insert and a removable closure. The deformable insert may have insert interior housing and a plurality of products. At least a portion of the deformable insert is received within a portion of the container interior. The deformable insert has an inner surface defining at least one grip extending towards the deformable insert interior. A removable closure may cover the insert interior.

In an embodiment, the lid and the body of the reclosable container are connected by a hinge.

In an embodiment, the deformable insert is made from plastic.

In an embodiment, the plurality of products is a plurality of tablets.

In an embodiment, the removable closure is removably sealed to the insert.

In still yet another embodiment, a method for inserting a refill into a container may comprise providing a container having a container interior and an annular bead extending towards the container interior. The method may also include providing a refill package having a removable insert defining an insert interior for housing a plurality of products. The refill package may also comprise a closure covering the insert interior. The method may also comprise the steps of: (a) opening the container to expose the container interior, (b) disengaging the closure from the insert, and (c) introducing the removable insert into the container interior so that the bead locks the insert within the container interior.

In a further embodiment, a method for removing a refill from a container is disclosed. The method may comprise providing a container and a refill package. The container comprises a container interior. The refill package comprises a deformable insert having an insert interior housing a plurality of products and an inner surface defining a pair of grips. Each grip extends towards the insert interior. The insert is so constructed and arranged to be received within a portion of the container interior. The method may also comprise the steps of: (a) opening the container to expose the container interior and the deformable insert, (b) engaging each of the grips, (c) applying a force to each of the grips in a direction towards the insert interior; and (d) separating the deformable insert from the container interior.

In another embodiment, a method for marketing products housed in a container is disclosed. The method may comprise providing a reclosable container defining a container interior where the container interior is initially empty. The method may also comprise providing a plurality of refill packages where each refill package includes a refill body and a removable closure. The refill body has a body interior for housing a plurality of products and the removable closure covers the body interior. The method may also comprise (a) arranging the reclosable container and the plurality of refill packages inside a final package, and (b) instructing a consumer to disengage the removable closure from the refill body and to insert the refill body inside the container interior.

In an embodiment, instructions may be printed on one of the reclosable container, refill package, and final package.

In an embodiment, instructions may be provided as an insert within the interior of the final package.

It is therefore an advantage of the present disclosure to provide an improved product container.

It is also an advantage of the present disclosure to provide consumable product containers that are portable and stylish.

It is another advantage of the present disclosure to provide consumable product containers that are reusable and refillable.

It is yet another advantage of the present disclosure to provide consumable product containers that are sized to fit in a pocket or a purse.

It is a further advantage of the present disclosure to provide consumable product containers that are easy to open.

Additional features and advantages are described herein, and will be apparent from, the following Detailed Description and the figures.

### BRIEF DESCRIPTION OF THE FIGURES

FIG. 1 illustrates a perspective view of an embodiment of the refillable package in accordance with an embodiment of the present disclosure.

FIG. 2 illustrates a top view of an embodiment of the refill tray in accordance with an embodiment of the present disclosure.

FIG. 3 illustrates a cross-sectional view of the refill tray of FIG. 2 along line A-A.

FIG. 4 illustrates a top view of the refillable package in a closed position in accordance with an embodiment of the present disclosure.

FIG. 5 illustrates a cross-sectional view of the refillable package of FIG. 4 along line B-B.

FIG. 6 illustrates an expanded view of a refillable package of FIG. 5 within C.

FIG. 7A and FIG. 7B illustrate a final package for marketing products housed in a refillable package in an open and closed position, respectively, in accordance with an embodiment of the present disclosure.

### DETAILED DESCRIPTION

The present disclosure provides a refillable package for housing a plurality of solid consumable products. Although the consumable products are illustrated as tablets or products in the figures, it will be understood that the products to be dispensed may be of any suitable shape and size. Examples of such shapes include, but are not limited to, pill, block, flat stick, pillow, round, rectangular, triangular, or any combination thereof. In an embodiment, the products housed in the receptacle may be confectionery products including, but not limited to, hard candies, gummy candies, mints, tablets, gum pellets, beads, liquid filled beads, chewy candy, chocolate, caramels, and gumballs. In another embodiment, the products may be snack foods including, but not limited to, peanuts, nuts, pretzels, and salty snacks.

In another embodiment, the products can alternatively be any other type of solid consumable product. For example, the products can be cough drops or breath mints or other types of consumable medicament products. In a further embodiment, the container may include combinations of different products. It should also be appreciated that the container may house non-edible products of similar size and shape. The teachings of the present disclosure, therefore, are not dependent upon the products being of any particular type so long as the products fit within and may be dispensed by the product container described herein.

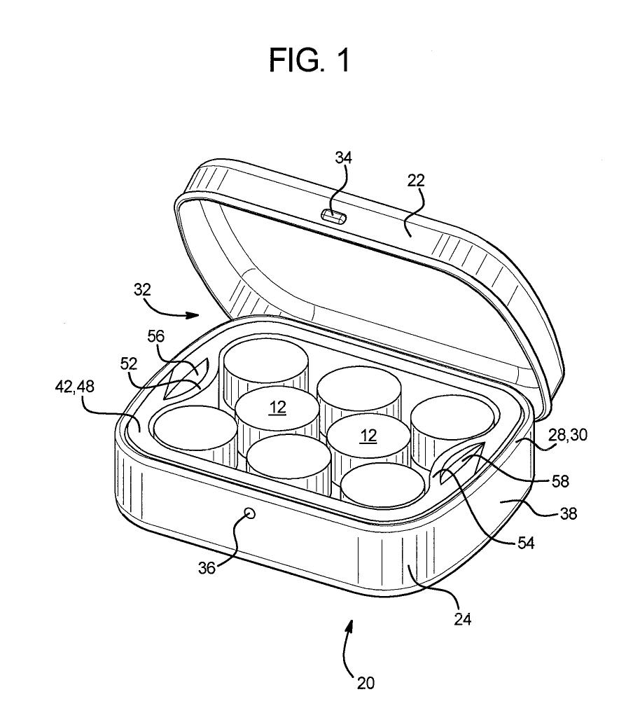

Referring now to the drawings and in particular to FIG. 1, one embodiment of a refillable package may include a reclosable container 20. The reclosable container 20 may have a lid 22 and a body 24. The body 24 may include a container interior 26 therein. The lid 22 may be connected to the body 24 by a hinge 32 so as to removably cover the container interior 26. As seen in FIG. 1, the lid 22 may have a first lock portion 34 and the body 24 may have a second lock portion 36 corresponding to the first lock portion 34 of the lid 22. The lock portions 34 and 36 may interact with one another to provide a snap-fit seal between the lid 22 and the body 24 of the reclosable container 20 when the lid 22 is in a closed position. The lock portions 34 and 36 may operate to secure the reclosable container 20 in the closed position so that it does not open when it is dropped or agitated. Lock portion 34 may also be a finger ledge to allow the user to open the reclosable container 20. Further, the body 24 of the reclosable container 20 may include a rim 28 located along its periphery. In an embodiment, the rim 28 may comprise a single annular bead 30 where the annular bead 30 may extend inward toward the interior 26 of the body 24.

The reclosable container 20 is not limited to any particular size or shape as long as the products 12 contained therein may be dispensed therefrom. As shown in FIG. 1, the container may be generally shaped as a flat receptacle. However, the container may be any suitable size and shape including, but not limited to, cubic, rectangular, pyramidal, cylindrical, conical and spherical shapes, and combinations thereof. In an embodiment, the container may graduate from one size or shape to another size or shape along a total length thereof.

In an embodiment, the reclosable container 20 may be of limited capacity, providing only a small amount of consumable products to the consumer. In this embodiment, the reclosable container 20 may be portable and suitable for use in different environments. For example, the container may be sized and shaped to conveniently fit in a consumer's pocket or purse. With its compact size, a consumer may be encouraged to bring the reclosable container 20 with them throughout the day. Similarly, in an embodiment, the reclosable container 20 may measure about two and one-third inches long, about one and three-fourths inches wide and about half an inch deep. However, the skilled artisan will appreciate that the dimensions of the reclosable container 20 may vary as desired or in accordance with manufacturing specifications.

The lid 22 of the reclosable container 20 may be directly attached to the body 24 by a hinge 32. In an embodiment, the hinge 32 may be a pin hinge where the lid 22 may pivot at the location of the pin. However, other suitable hinges may used including, but not limited to, living hinges, spring hinges, or the like.

The reclosable container 20 may be made from a sufficiently rigid material to prevent the container from deforming or opening upon application of pressure to the reclosable container 20 when, for example, the reclosable container 20 is squeezed. In an embodiment, the reclosable container 20 may be made from a metal material. The metal material may include tin, aluminum, steel, tempered steel, stainless steel, or the like, or combinations thereof. The container may be constructed using conventional sheet metal processes including, but not limited to, punching, rolling, shaping and welding. The use of a metal material in forming the reclosable container 20 provides the reclosable container 20 with a sophisticated appearance that may be desirable to consumers.

Further, the metal material of the reclosable container 20 may be coated with an inert coating to prevent the metal material from contacting consumable products contained within the reclosable container 20. The inert coating may be any coating that is approved by the Food and Drug Administration (FDA) for use with consumable products. Specifically, the inert coating may be an FDA approved varnish. Alternatively, the inert coating may be any material that serves as an inert coating, thin film, inert layer, or the like, or combinations thereof, intermediate the metal material and the consumable products 12. The inert coating may have a thickness from about 0.1 mm to about 1.0 mm, or any value therebetween. Similarly, the inert coating may have a thickness of about 0.5 mm.

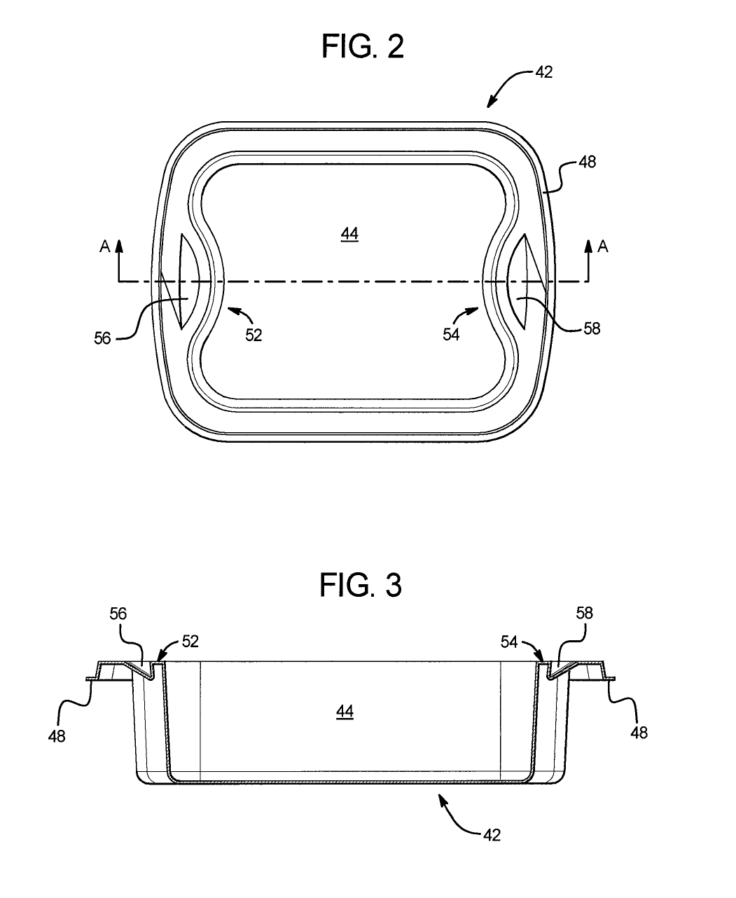

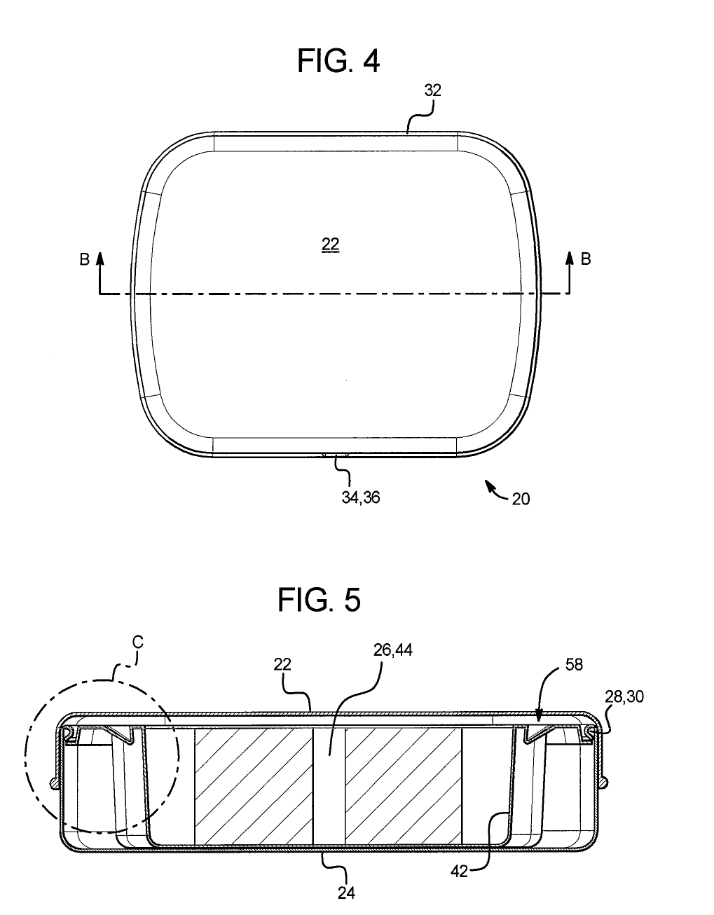

In an embodiment, the refillable package may also include an insertable refill 40. The insertable refill 40 may comprise a removable closure 46 and an insertable tray 42, as is illustrated in FIG. 2. As shown in FIG. 1, the tray interior 44 may house the plurality of consumable products 12 therein.

In an embodiment, the tray 42 may be made from a plastic material. The plastic material may be polyethylene, polypropylene, or the like, or combinations thereof. The tray 42 may be constructed using conventional molding processes including, but not limited to, injection blow molding, extrusion blow molding and injection molding. In an embodiment, the tray 42 is constructed using conventional thermoforming techniques. The plastic material of the tray 42 may be of a sufficient thickness to provide the tray 42 with some elasticity. In other words, the tray 42 may be only thick enough so as not to break or crack when handled during manufacturing or by the consumer. As shown in an embodiment in FIG. 3, the tray 42 may have a uniform thickness throughout.

The use of a plastic material in making the tray 42 may also help to protect and/or to orient the consumable products 12 contained within the tray interior 44. In an embodiment, the tray 42 may be thermoformed such that it is molded along the tray interior 44 with a raised pattern. This raised pattern may help to orient the consumable products 12 in a certain configuration within the tray interior 44. The raised pattern may take any shape or form including, but not limited to, raised bumps, circles, squares, rectangles, cylinders, ovals, and the like, or combinations thereof. For example, the tray interior 44 may comprise a plurality of bumps molded into, for example, a bottom surface of the tray interior 44 where the bumps define interstitial spaces therebetween. The consumable products 12 may then be placed substantially within the interstitial spaces between the bumps thereby limiting the movement of the consumable product 12 within the tray interior 44. The bumps may be disposed at regular intervals in a pattern of rows and columns. However, it will be appreciated that the bumps may be disposed in any pattern desired or according to manufacturing or packaging specifications.

In another embodiment, the plastic material of the tray 42 may help reduce noise when the reclosable container is agitated and the consumable products 12 are rattled therein. In another embodiment, the plastic material of the tray 42 may cushion the consumable products within the tray interior 44, thereby preventing the consumable products 12 from breaking when the reclosable container 20 is agitated and the consumable products 12 collide with the sidewalls 38 of the reclosable container 20. For example, in an embodiment, the consumable products 12 may be compressed mint tablets. In this embodiment, the plastic material of the tray 42 may help to prevent the mints from breaking into pieces.

In an embodiment, a removable closure 46 may be sealed onto a periphery 48 of the tray 42. The removable closure 46 may be used to keep the consumable products 12 fresh, to extend the shelf life of the consumable products 12, and may also help to prevent the release of excess particulate matter from a consumable product 12 within the tray interior 44. In an embodiment, the removable closure 46 may be a layer of film that is sealed onto a periphery 48 of the tray 42. In an embodiment, the seal may include an adhesive applied between the removable closure 46 and the periphery 48 of the tray 42. In another embodiment, the removable closure 46 is sealed onto the periphery 48 of the tray 42 using conventional conductive sealing techniques. For example, conductive heating may be used to melt an underside of the removable closure 46 onto the periphery 48 of the tray 42. Alternatively, conventional induction sealing techniques may also be used including, but not limited to, cold sealing, heat sealing utilizing a hot melt, heat activated adhesive or fusible substrate, room temperature sealing utilizing room temperature adhesives, or other induction sealing processes utilizing conductive foil systems. When a consumer first receives the insertable refill 40, the consumer may remove the closure 46 from the tray 42 so as to break the conductive seal therebetween and to expose a tray interior 44 containing a plurality of consumable products 12.

The consumer may access the container interior 26 by removing the lid 22 of the reclosable container 20. Similarly, the refill tray 42 may be so constructed and arranged that it may be inserted into the container interior 26. For example, the periphery 48 of the tray 42 may be shaped to correspond with the shape of the container interior 26. More specifically, the tray periphery 48 may be so constructed and arranged to fit inside the body 24 such that when the tray 42 is inserted into the container interior 26, the periphery 48 is seated beneath the annular bead 30 of the container body 24. Thus, the annular bead 30 of the container body 24 may lock the refill tray 42 within the container interior 26.

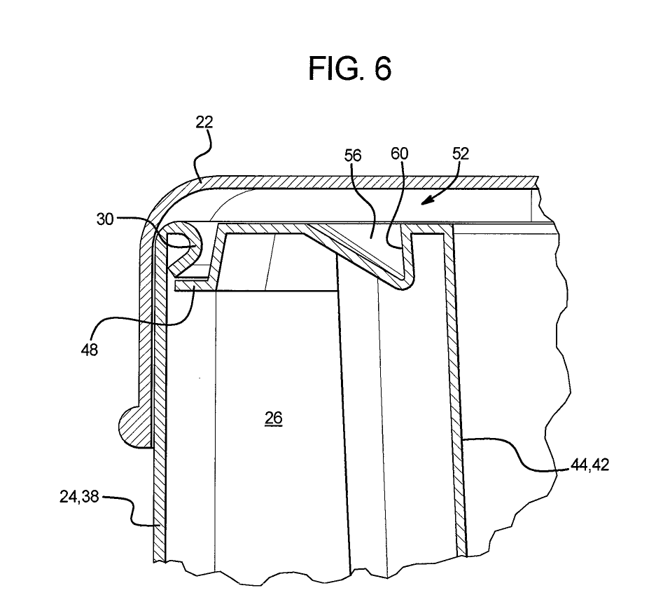

As best illustrated in FIGS. 5 and 6, the annular bead 30 of the container body 24 may fasten the tray periphery 48 therein and secure the entire tray 42 inside the container interior 26. In other words, the maximum dimensions along the periphery 48 of the tray 42 may be slightly and uniformly larger than the dimensions of the container body 24 at the innermost portions of the annular bead 30. However, the maximum dimensions along the periphery 48 of the tray 42 may still be slightly and uniformly smaller than the dimensions of the container body 24 along the sides 38 of the reclosable container 20. In other words, the periphery 48 of the tray 42 may be sized smaller than the container body 24 but larger than a rim 28. In this regard, the tray 42 may fit inside the container interior 26 but may not accidentally slide out of same while the lid 22 is open and the body 24 is tilted at an angle with respect to a horizontal plane.

It should be understood that the insertable refill 40 is not limited to any particular size or shape as long as the consumable products 12 are able to fit inside the tray interior 44 and the insertable refill 40 is sized and shaped to correspond with the shape of the container interior 26. For example, the tray 42 may be deeper than shown in the embodiments of the figures, and may house numerous layers of consumable product 12.

It is also an advantage of the present disclosure to provide a container that is reusable and easily refillable. In carrying out this aspect of the disclosure, the tray 42 may be easily removed from the reclosable container 20. In an embodiment, the tray 42 may include along its periphery 48 at least one grip defined therein and extending toward the tray interior 44. In an embodiment, the tray 42 may include a pair of opposing grips 52, 54 along an inside of the periphery 48, as shown in FIG. 2. The grips 52, 54 may be D-shaped. In other words, each grip may include a portion of the periphery 48, an aperture 56, 58 and a grip portion 52, 54. However, it is understood that the grips 52, 54 are not limited to any particular size or shape.

The grips 52, 54 may enable a consumer to lift the tray 42 out of the container interior 26. For example, a consumer may insert or remove the tray 42 from the reclosable container 20 using a thumb and an index finger. More specifically, a consumer can insert a thumb into an aperture 56 of a first grip 52 and an index finger into an aperture 58 of a second grip 54. As illustrated in FIGS. 3 and 6, the apertures may be of a sufficient depth to allow a consumer to contact an inner wall 60 of the grips 52, 54 using their fingernails. The consumer may then apply an inward force to the grips 52, 54 in a direction toward the interior 44 of the tray 42. In an embodiment, the grips 52, 54 and the tray 42 may be made from thin thermoform plastic so as to slightly bend and flex as needed. The inward force bends portions of the tray periphery 48 away from the sidewalls 38 and the rim 28 of the container body 24, while at the same time releases the periphery 48 from beneath the annular bead 30. In other words, squeezing the grips 52, 54 toward a tray interior 44 can unlock the tray 42 from the body 24 of the reclosable container 20. In this way, a consumer may easily lift the refill tray 42 out of the reclosable container 20 when the tray 42 is empty simply by using the grips 52, 54.

The present disclosure also includes a method for inserting a refill into a container. The method includes providing a reclosable container 20 having a lid 22 and a body 24. The body defines a container interior 26 and a rim 28. The rim 28 includes an annular bead 30 extending toward the container interior 26. The method also includes providing a refill package 40 including a deformable tray 42 defining a tray interior 44 for housing a plurality of products therein 12. The refill package 40 also includes a removable closure 46 for covering the tray interior 44. The interior 44 of the tray 42 includes a periphery 48 which is so constructed and arranged to fit along an inside surface of the rim 28. The method further includes the steps of: (a) opening the reclosable container 20 between the lid 22 and the body 24 to expose the body interior 26, (b) removing the removable closure 46 from the tray 42, and (c) inserting the tray 42 into the container interior 26 so that the annular bead 30 locks the periphery 48 of the tray 42 within the container interior 26.

The present disclosure further includes a method for removing a refill from a container. The method includes providing a reclosable container 20 having a lid 22 and a body 24. The body 24 may have a container interior 26. The method also includes providing a refill package 40 including a deformable tray 42 defining a tray interior 44 for housing a plurality of products 12 therein. The tray 42 also includes an inner surface defining a pair of grips 52, 54. Each grip 52, 54 extends toward the tray interior 44 and includes a grip portion 52, 54 and an aperture 56, 58. The tray 42 is so constructed and arranged to be received within a portion of the container interior 26. The method further includes the steps of: (a) opening the reclosable container 20 between the lid 22 and the body 24 to expose the container interior 26 and the deformable tray 42, (b) engaging each of the grips, (c) applying a force to each of the grip portions 52, 54 in a direction towards the tray interior 44, and (d) lifting the deformable tray 42 out of the container interior 26.

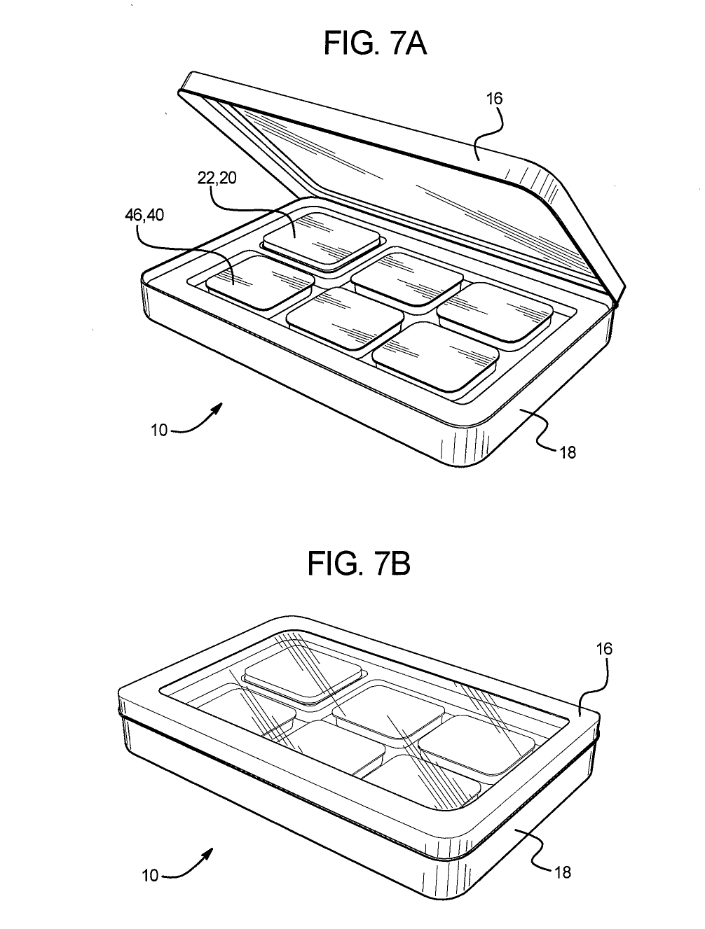

FIG. 7A and FIG. 7B illustrate a final package 10 containing a single reclosable container 20 and a plurality of refill packages 40. The final package 10 may include a top 16 hingedly connected to a base 18. The top 16 may include a window therein to allow the reclosable container 20 and the plurality of refill packages 40 to be visible through the top 16.

In an embodiment (not shown) a final package 10 may comprise a base 18 containing a single reclosable container 20 and a plurality of refill packages 40 and may further comprise an outer sleeve having a hollow interior. The base 18 may be slidably inserted within the hollow interior of the sleeve, thereby mimicking the action of a matchbox. In this embodiment, the hollow sleeve may act as a lid or cover for the final package 10. The outer sleeve may be made of paperboard and may have a thin plastic film window located on the top portion of the sleeve thereby allowing the contents of the final package 10 to be viewed by a consumer when the base 18 containing the reclosable container 20 and the refill packages 40 is inserted within the hollow interior of the sleeve. Similarly, the outer sleeve may be made entirely of paperboard having graphics or indicia provided thereon.

As shown in FIGS. 7A and 7B, the lid 22 of the reclosable container 20 and the removable cover 46 of the refill packages 40 may include indicia 14 provided thereon. The indicia 14 may include logos, advertisements, branding information, nutritional information, product information, manufacturer information, or the like, or combinations thereof. The indicia may also be provided in a number of ways. For example, in an embodiment, the indicia may be printed on a pressure sensitive material (e.g. sticker) to be applied to the lid 22 or removable cover 46. In another embodiment, the indicia 46 may be printed directly on the lid 22 or removable cover 46.

The present disclosure also provides a method for marketing products housed in a final package 10. The method includes providing a reclosable container 20 defining a container interior 26, and a plurality of refill packages 40 each comprising a refill body 42 having a body interior 44 for housing a plurality of solid products 12. The refill packages 40 also each include a removable closure 46 covering the body interior 44. The method also includes the steps of: (a) arranging the reclosable container 20 and the plurality of refill packages 40 together inside a final package 10, and (b) instructing a consumer to remove the removable closure 46 from the body 42 and to place the body 42 inside the container interior 26.

The reclosable container 20 may initially be empty as provided in the final package 10 so as to bring to a consumer's attention that he must first insert a refill package 40 into the container interior 26. Since the reclosable container 20 will not house any consumable products 12, the consumer will be forced to open at least one of the refill packages 40 to obtain access to the consumable products. The consumer may then remove the removable closure 46 of one refill package 40 to expose the consumable products 12 located inside the interior 44. In doing so, the consumer will also notice that once the closure 46 is removed, it cannot be replaced to cover the refill package 40. Thus, the consumer will understand that the body or tray 42 of the refill package 40 may be designed to be placed within the container interior 26 of the reclosable container 20. Therefore, it will be intuitive that the single container 20 is to function as a reusable housing for the plurality of refill packages 40.

In an embodiment, instructions may be printed on an outside of the reclosable container, refill package, or final package. In another embodiment, instructions may be printed on an inside of the top 16 of the final package 10. In another embodiment, instructions may be provided as a leaflet or paper insert within an interior of the final package 10.

The final package 10 may house a plurality of refill packages 40 therein. In an embodiment, the final package 10 includes one reclosable container 20 and five refill packages 40. Small consumable products may typically be packaged into a much smaller final package relative to the final package 10 of the present disclosure. In this regard, such small final packages housing similar consumable products may be placed on impulse racks near the checkout counter at a store. As shown in FIGS. 7A and 7B, a final package 10 can include a large supply of refill packages 40 and can be used to sell the consumable products 12 in bulk. At the same time, the limited sizes of the reclosable container 20 and the refill packages 40 are small enough so that a consumer may remove them from the final package 10 and may carry around a portable reclosable container 20 of consumable products 12.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A package comprising:
a container comprising a lid and a body comprising a container interior and a bead; and
a removable refill comprising an insert defining an insert interior housing a plurality of products and a closure covering the insert interior, the insert being so constructed and arranged to be received within a portion of the container interior and cooperating with the bead to secure the insert within the container interior.

2. The package of claim 1 wherein the insert comprises a deformable plastic.

3. The package of claim 1 wherein the lid and the body are connected by a hinge.

4. The package of claim 1 wherein the plurality of products is a plurality of tablets.

5. The package of claim 1 wherein the closure is removably attached to the insert.

6. A package comprising:
a deformable body comprising an interior housing, a plurality of products and an inner surface defining a pair of grips extending toward the interior housing, the grips being so constructed and arranged as to allow the deformable body to be carried thereby; and
a closure removably covering the interior housing.

7. The package of claim 6 wherein the pair of grips are located on opposing sides of the inner surface.

8. The package of claim 6 wherein the plurality of products is a plurality of solid consumable products.

9. The package of claim 6 wherein the deformable body comprises thermoform plastic.

10. The package of claim 6 wherein the closure is a film.

11. A package comprising:
a reclosable container comprising a lid and a body having a container interior; and
a refill comprising a deformable insert having an insert interior housing a plurality of products and a removable closure covering the insert interior, at least a portion of the deformable insert being received within a portion of the container interior and comprising an inner surface defining at least one grip extending towards the insert interior.

12. The package of claim 11 wherein the lid and the body are connected by a hinge.

13. The package of claim 11 wherein the deformable insert comprises plastic.

14. The package of claim 11 wherein the plurality of products is a plurality of tablets.

15. The package of claim 11 wherein the removable closure is removably sealed to the insert.

16. A method for inserting a refill into a container, the method comprising:
providing a container comprising a container interior and an annular bead extending towards the container interior, a refill package comprising a removable insert having an insert interior housing a plurality of products and a closure covering the insert interior;
opening the container to expose the container interior;
disengaging the closure from the insert; and
introducing the removable insert into the container interior so that the bead locks the removable insert within the container interior.

17. A method for removing a refill from a container, the method comprising:
providing a container comprising a container interior, a refill package including a deformable insert comprising an insert interior housing a plurality of products and an inner surface defining a pair of grips, each grip extending towards the insert interior, the insert being so constructed to be received within a portion of the container interior;
opening the container to expose the container interior and the deformable insert;
engaging each of the grips;
applying a force to each of the grips in a direction towards the insert interior; and
separating the deformable insert from the container interior.

18. A method for marketing products housed in a container, the method comprising:
providing a reclosable container defining a container interior, wherein the container interior is initially empty, and a plurality of refill packages, each refill package comprising a refill body having a body interior housing a plurality of products and a removable closure covering the body interior; and
arranging the reclosable container and the plurality of refill packages inside a final package.

19. The method of claim 18 further comprising instructing a consumer to disengage the removable closure from the refill body and to insert the refill body inside the container interior.

20. The method of claim 19 wherein instructions are printed on one of the reclosable container, refill package, and final package.

21. The method of claim 19 wherein instructions are provided as an insert within an interior of the final package.
